(19) United States
(12) Patent Application Publication
(10) Pub. No.: US 2007/0149198 A1
(43) Pub. Date: Jun. 28, 2007

(54) Method and apparatus for measuring amount of user traffic of handover terminals in wireless communication system

(75) Inventors: Chul Park, Daejeon-city (KR); Chul-Sik Yoon, Daejeon-city (KR)

Correspondence Address: THE FARRELL LAW FIRM, P.C., 333 EARLE OVINGTON BOULEVARD, SUITE 701, UNIONDALE, NY, 11553, US

(73) Assignees: SAMSUNG ELECTRONICS CO., LTD., Suwon-si (KR); Electronics and Telecommunications Research Institute, Yuseong-gu (KR); KT Corporation, Seongnam-city (KR); SK TELECOM CO., LTD, Seoul (KR); HANARO TELECOM., INC., Seoul (KR)

(21) Appl. No.: 11/636,781

(22) Filed: Dec. 11, 2006

(30) Foreign Application Priority Data
Dec. 10, 2005 (KR) 10-2005-0121372

(51) Int. Cl. H04Q 7/20

(52) U.S. Cl. 455/436; 455/453

(57) ABSTRACT

A user traffic amount measuring device in a mobile communication system may measure and analyze an amount of traffic used in a second base station by a mobile station performing a handover from a first base station to the second base station. In this case, without changing a configuration of the mobile communication system, the amount of traffic used by the mobile station having performed the handover to the base station may be measured for each subscriber by using information allocated for each basic connection identifier based on downlink and uplink MAP information elements included in a downlink frame broadcasted by the base station.

### PRIORITY

This application claims priority under 35 U.S.C. §119 to a Korean application filed in the Korean Intellectual Property office on Dec. 10, 2005 and allocated Serial No. 10-2005-0121372, the contents of which are incorporated herein by reference.

### BACKGROUND OF THE INVENTION

(a) Field of the Invention

The present invention relates to a mobile communication system. More particularly, the present invention relates to a device and method for measuring and analyzing an amount of traffic of a user.

(b) Description of the Related Art

A portable Internet system, which is one of mobile communication systems, is defined by the IEEE802.16-2004, IEEE802.16e-2005, and IEEE802.16-2004/Cor1-2005 standards. In the portable Internet system, since a terminal, a base station, and a router are defined to be compatible with an existing public Internet protocol (IP) network and the terminal may have mobility, an IP-based network service may be provided through the terminal having mobility while on the move.

Various methods for analyzing traffic of the terminal in the mobile communication system including the portable Internet system have been disclosed, but a system and method for analyzing an amount of traffic used after a mobile terminal performs a handover from a first base station to a second base station and accesses the second base station has yet to be disclosed.

### SUMMARY OF THE INVENTION

The present invention has been made in an effort to provide a method and device for measuring an amount of traffic used in a base station to which a mobile station performs a handover.

In an exemplary method for measuring an amount of traffic used in a second base station by a mobile station performing a handover from a first base station to the second base station, downlink resource size information for each mobile station identifier is extracted based on downlink MAP (DL-MAP) information elements of a transmission frame broadcasted from the second base station, uplink resource size information for each mobile station identifier is extracted based on uplink MAP (UL-MAP) information elements of the transmission frame broadcasted from the second base station, a handover identifier (ID) indicating the handover of the mobile station is set to correspond to the mobile station identifier corresponding to the mobile station identifier of the ranging response message when the handover ID exists in a ranging response message broadcasted from the second base station, and the amount of traffic used by the mobile station having performed the handover in the second base station is measured based on the downlink resource size information, the uplink resource size information, and the handover ID.

An exemplary device for measuring an amount of traffic used in a second base station by a mobile station performing a handover from a first base station to the second base station includes a frame receiving unit, a downlink/uplink mobile station identifier information extracting unit, a handover identifier (ID) determining unit, an information storage unit, and a traffic calculating unit. The frame receiving unit receives a downlink frame broadcasted from the second base station. The downlink/uplink mobile station identifier information extracting unit extracts predetermined mobile station identifier information based on a downlink MAP information element (DL-MAP IE) and an uplink MAP information element (UL-MAP IE) included in the received downlink frame. The handover identifier (ID) determining unit determines whether a ranging response message broadcasted from the second base station includes a handover ID indicating the handover of the mobile station. The information storage unit stores the extracted mobile station identifier information and the handover ID. The traffic calculating unit calculates the amount of traffic of the mobile station having performed the handover to the second base station based on the downlink/uplink mobile station identifier and the information stored in the downlink/uplink mobile station identifier.

### BRIEF DESCRIPTION OF THE DRAWINGS

FIG. 1 shows a diagram of a configuration of a mobile communication system according to an exemplary embodiment of the present invention.

FIG. 2 shows a diagram of a configuration of a transmission frame according to the exemplary embodiment of the present invention.

FIG. 3 shows a diagram of a configuration of a MAP information element (IE) in the transmission frame according to the exemplary embodiment of the present invention.

FIG. 4 shows a diagram of a configuration of a traffic measuring device according to the exemplary embodiment of the present invention.

FIG. 5 shows a flowchart representing a method for measuring and analyzing an amount of traffic of the mobile station according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, unless explicitly described to the contrary, the word “comprise” and variations such as “comprises” or “comprising”, will be understood to imply the inclusion of stated elements but not the exclusion of any other elements.

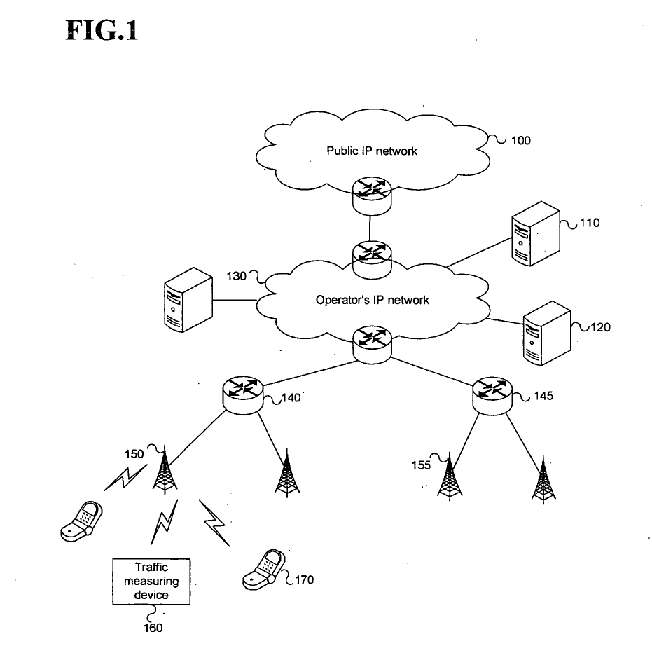

A device and method for measuring an amount of traffic of a mobile station performing a handover in a portable Internet system among mobile communication systems will be described. Particularly, when the mobile station performs the handover from a first base station to a second base station in the portable Internet system, the mobile station receives information on the amount of traffic used in the second base station from the second base station, and measures the amount of traffic. A system for measuring the amount of traffic will be described with reference to FIG. 1.

FIG. 1 shows a diagram of a configuration of a mobile communication system according to an exemplary embodiment of the present invention.

As shown in FIG. 1, in the mobile communication system according to the exemplary embodiment of the present invention, a public Internet protocol (IP) network 100 is connected to a mobile station 170, base stations 150 and 155, routers 140 and 145, and a traffic measuring device 160 for measuring an amount of traffic of the mobile station 170. Accordingly, in the exemplary embodiment of the present invention, the amount of traffic of the mobile station 170 may be measured without changing a configuration of a conventional portable Internet system.

The traffic measuring device 160 uses the mobile station 170 to measure and analyze the amount of traffic that is used by a subscriber to receive and use a service in one base station 155. Here, the traffic measuring device 110 is realized as a simplified terminal, and it may be used to measure and analyze the traffic.

The base stations 150 and 155 are connected to one operator's IP network 130. Accordingly, to receive an IP-based service by using the mobile station 170, a subscriber of a service is required to access the public IP network 100 through a base station 150 or 155 and the operator's IP network 130. The operator's IP network 130 is connected to a home agent (HA) server 110, an authentication and service authorization (ASA) server, and an authentication, authorization, and accounting (AAA) server 120.

The HA server 110 processes packet routing and mobile IP address information of the mobile station 170 accessed through the IP network to support mobility of a plurality of mobile stations 170. The AAA server 120 processes authentication, authorization, and accounting of the mobile station 170 accessed through the IP network. The above descriptions have been disclosed, and therefore detailed descriptions thereof will be omitted in the exemplary embodiment of the present invention.

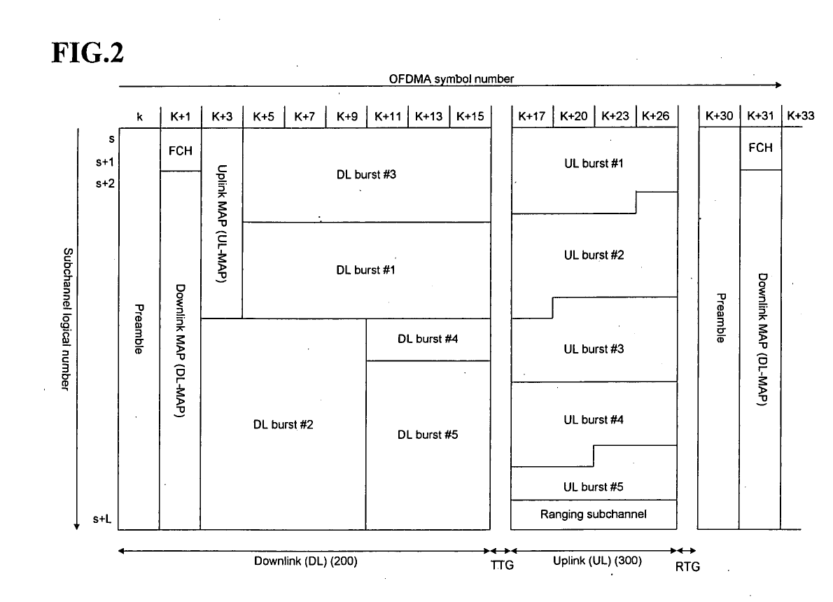

A configuration of a transmission frame transmitted between the mobile station 170 and the base stations 150 and 155 in the system shown in FIG. 1 will be described with reference to FIG. 2.

FIG. 2 shows a diagram of the configuration of the transmission frame according to the exemplary embodiment of the present invention.

As shown in FIG. 2, the transmission frame includes a downlink (DL) frame part 200 that is transmitted from the base stations 150 and 155 to the mobile station 170 and an uplink (UL) frame part 300 that is transmitted from the mobile station 170 to the base stations 150 and 155. A vertical axis of the frame shows subchannels including orthogonal frequencies, and a horizontal axis is a time-divided time axis.

The DL frame part 200 includes a preamble, a downlink MAP, an uplink MAP, and a plurality of downlink bursts. Channels and resources of the downlink bursts are not classified for each user, but they are classified for each transmission level having the same modulation method and the same channel skill. Accordingly, the downlink MAP uses a connection identifier (CID) to identify the mobile station 170 of a subscriber, and the base stations 150 and 155 use offset information, modulation method information, and coding information that correspond to the identified mobile station 170 to allocate resources for the mobile station 170.

Accordingly, the downlink MAP and the uplink MAP are used to transmit a location of a burst allocated to each user, and information commonly broadcasted to the mobile stations 170 of the subscribers in the transmission frame. Therefore, the downlink MAP has broadcast channel characteristics, and requires high robustness.

In addition, the UL frame part 300 is transmitted for each user, and a plurality of uplink bursts 211 have information for each user. The UL frame part 300 includes a ranging subchannel used by the mobile station 170 to periodically transmit a state of the mobile station 170 to the base stations 150 and 155.

A plurality of bursts included in the DL frame part 200 may be divided and formed for each subscriber. The respective mobile stations 170 transmit required control message and traffic information through the bursts. In this case, the mobile stations 170 in the base stations 150 and 155 may receive the DL/UL MAP.

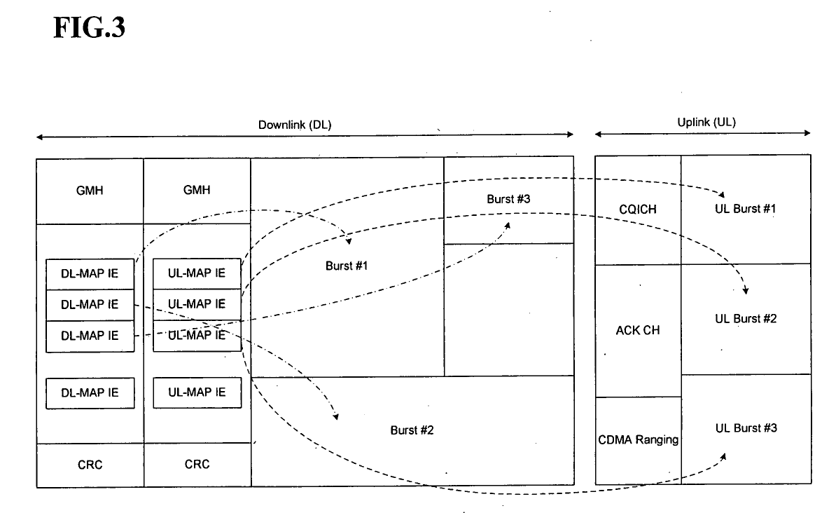

In the exemplary embodiment of the present invention, the amount of traffic used by the mobile station 170 having performed a handover from the first base station 155 to the second base station 150 is measured by using information commonly broadcasted from the base station to the subscribers by the MAP and bursts among the transmission frame of the portable Internet system. A configuration of MAP information included in the transmission frame used to measure the amount of traffic will be described with reference to FIG. 3.

FIG. 3 shows a diagram of a configuration of a MAP information element (IE) in the transmission frame according to the exemplary embodiment of the present invention.

As shown in FIG. 3, the MAP is classified as the downlink MAP for downlink transmission and the uplink MAP for uplink transmission, and the uplink and downlink MAPs include a plurality of uplink/downlink MAP IEs. The plurality of mobile stations 170 receive the uplink/downlink MAP in the downlink frame part of the transmission frame shown in FIG. 2, detect broadcast information and burst information allocated to the mobile station 170 from the uplink/downlink MAP, and perform uplink/downlink communication with the base stations 150 and 155 based on the detected information.

In a portable Internet system standard, when the mobile station 170 performs the handover from the first base station 155 to the second base station 150, it is defined that a handover ranging operation is performed to initially access the second base station. In addition, to perform the handover ranging operation, ranging request/ranging response (RNG-REQ/RNG-RSP) messages are transmitted between the second base station 150 and the mobile station 170.

In addition to the handover ranging operation, it is defied in the portable Internet system standard that an initial ranging operation is performed when the mobile station 170 initially access a network through the base stations 150 and 155. In this case, in a like manner of the handover ranging operation, the RNG-REQ/RNG-RSP messages are transmitted between the base stations 150 and 155 and the mobile station 170.

The mobile station 170 transmits the RNG-REQ message for the handover ranging to the second base station 150 to which the mobile terminal 170 performs the handover, when the mobile station 170 performs the handover from the first base station 155 to the second base station 150. The second base station 150 receiving the RNG-REQ message transmits the RNG-RSP message to the mobile station 170 in response to the RNG-REQ message. When the mobile station 170 transmits the RNG-REQ message to the second base station 150, the RNG-REQ message includes a medium access control (MAC) address of the mobile station 170.

The second base station 150 uses the MAC address of the mobile station 170 in the RNG-REQ message to transmit the RNG-RSP message to the mobile station 170 having transmitted the RNG-REQ message. In this case, the RNG-RSP message includes a mobile station identifier that is a value defined to separately manage the second base station 150 and the mobile station 170. In the exemplary embodiment of the present invention, a basic connection identifier is exemplified as the mobile station identifier, but it is not limited thereto.

In addition, when the mobile terminal 170 having transmitted the RNG-REQ message performs the handover, the RNG-RSP message is transmitted while including a handover ID indicating a response to the mobile station 170 having performed the handover. The RNS-RSP message transmitted/received by the initial ranging operation does not include the handover ID.

As described above, the RNG-RSP message includes the MAC address of the mobile terminal, and the basic CID, and it selectively includes the handover ID. In addition, the RNG-RSP message transmitted by the base stations 150 and 155 has characteristics defined in the portable Internet standard as follows.

Since the burst including the RNG-RSP message uses a fixed modulation method, all the mobile stations may modulate the RNG-RSP message.

The RNG-RSP message is broadcast information transmitted to the mobile station by the base station.

According to the characteristics of the RNG-RSP message, the following information may be obtained by using the handover ID, the MAC address, and the basic CID in the RNG-RSP message transmitted from the base station 150.

The MAC address of the mobile stations having performed the handover from the first base station to the second base station.

The basic CID provided from the second base station to the mobile stations having performed the handover from the first base station to the second base station.

Therefore, since the traffic measuring device 160 according to the exemplary embodiment of the present invention receives the RNG-RSP messages from the second base station 150 and analyzes the RNG-RSP message including the handover ID, it may detect the MAC address and the basic CID of the mobile stations having performed the handover to the second base station 150. Accordingly, the traffic measuring device 160 may separately manage the mobile stations 170 having performed the handover to the second base station 150, and the mobile station 170 initially accessed to the second base station 150 without the handover.

The respective downlink/uplink MAPs include a plurality of MAP IEs. The downlink/uplink MAPs and the MAP IE forming the downlink/uplink MAPs have characteristics as follows.

The downlink/uplink MAP is the broadcast information, and the mobile terminals of the base station including the traffic measuring device 160 according to the exemplary embodiment of the present invention may receive the downlink/uplink MAP.

A predetermined MAP IE in the downlink/uplink MAP includes resource allocation information for a predetermined basic CID. The resource allocation information includes the number of slots, and adaptive modulation and coding (AMC) level information.

When resource allocation is performed, the base stations 150 and 155 allow the mobile station 170 to use resources of the base stations 150 and 155 so that uplink or downlink communication may be performed between the various mobile stations 170 and one base station.

In addition, the slot expressed by a product of the subchannel and symbol shown in FIG. 2 is a basic unit of the resources. A size of the bandwidth used for uplink/downlink transmission between the base stations 150 and 155 and the mobile station 170 is expressed by using the slot. The AMC level is information indicating the modulation method and the channel coding method used to transmit the slot used to perform the uplink or downlink transmission, and a data rate indicating an amount of information transmitted by a predetermined number of slots may be detected by the AMC level.

Accordingly, when the uplink/downlink MAPs are received, and the AMC level and the number of slots allocated to the mobile station 170 that has the basic CID and is accessed to the second base station 150 by performing the handover are analyzed, sizes of uplink and downlink resources allocated to the mobile station 170 having the basic CID may be detected. The sizes of uplink and downlink resources are the same as the amount of traffic used in one transmission frame by the mobile station 170 using the basic CID in the base stations 150 and 155.

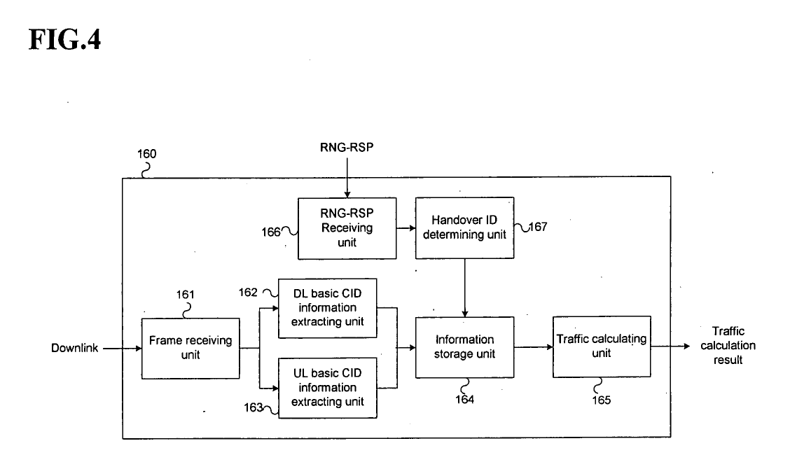

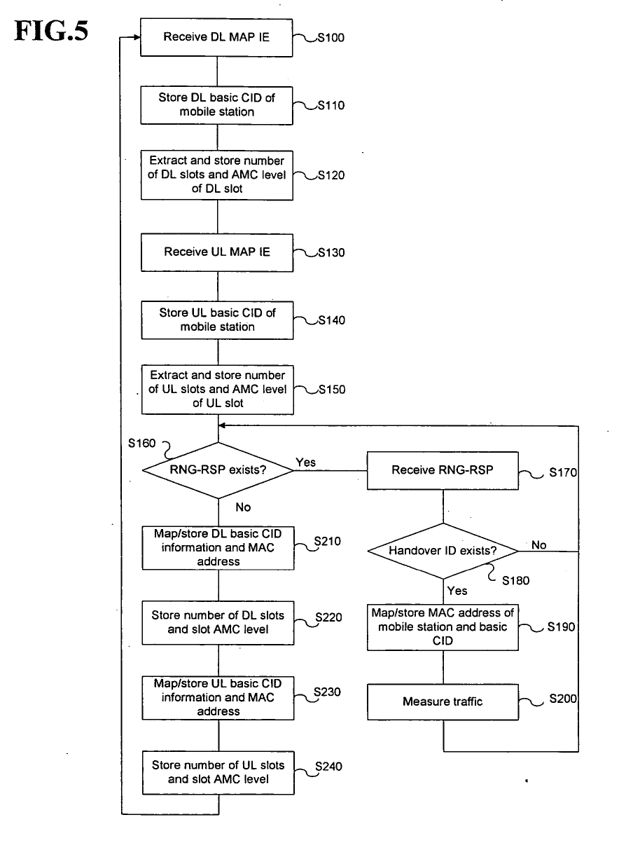

A configuration of the traffic measuring device 160 for measuring and analyzing the traffic of the user based on the transmission frame having the above characteristics and a method for measuring the traffic of the mobile station 170 having performed the handover by using the traffic measuring device 160 will be described with reference to FIG. 4 and FIG. 5.

FIG. 4 shows a diagram of a configuration of the traffic measuring device according to the exemplary embodiment of the present invention.

As shown in FIG. 4, the traffic measuring device 160 includes a frame receiving unit 161, a DL basic CID information extracting unit 162, a UL basic CID information extracting unit 163, an information storage unit 164, a RNG-RSP receiving unit 166, a handover ID determining unit 167, and a traffic calculating unit 165.

The frame receiving unit 161 receives the transmission frame broadcasted from the base stations 150 and 155 to the mobile stations 170.

The DL basic CID information extracting unit 162 and the UL basic CID information extracting unit 163 respectively extract the number of slots allocated to the basic CID and the AMC level information in relation to the downlink transmission and the number of slots allocated to the basic CID and the AMC level information in relation to the uplink transmission from the transmission frame transmitted from the frame receiving unit 161.

The RNG-RSP receiving unit 166 determines whether the RNG-RSP message is transmitted from the base station 150 to the mobile station 170, and receives the RNG-RSP message when there is an RNG-RSP message transmitted from the base station 150 to the mobile station 170. The RNG-RSP message includes the MAC address of the mobile station 170, the basic CID, and the handover ID, which are input to the information storage unit 164 and are stored therein.

The handover ID determining unit 167 determines whether the burst including the control message and the traffic information that are classified for each subscriber of the mobile station 170 and are required for each subscriber includes the handover ID among the downlink/uplink MAPs and the burst that are the constituent elements of the transmission frame received by the RNG-RSP receiving unit 166.

While the RNG-REQ/RNG-RSP messages are transmitted between the second base station 150 and the mobile station 170 to perform the handover ranging operation, the handover ID indicating a response to the RNG-REQ message of the mobile station 170 having performed the handover is added to the RNG-RSP message and is transmitted to the mobile station 170.

When the mobile station 170 has performed the handover, the burst including the RNG-RSP message includes the handover ID. In this case, the handover ID determining unit 167 determines the handover ID included in the burst. A method for generating the handover ID has been disclosed, and therefore detailed descriptions thereof will be omitted in the exemplary embodiment of the present invention.

The information storage unit 164 correspondingly stores the number of slots and the AMC level information extracted by the DL basic CID information extracting unit 162 and the UL basic CID information extracting unit 163, and the handover ID, the MAC address, and the basic CID extracted by the handover ID determining unit 167 according to a determination result of the handover ID by the handover ID determining unit 167 when the corresponding mobile station 170 performs the handover. However, when the mobile station 170 does not perform the handover, the MAC address, the basic CID, the number of slots, and the AMC level are correspondingly stored.

The traffic calculating unit 165 calculates a size of a band used to perform the uplink and downlink transmission and a size of resources according to the band size based on the number of slots and the AMC level information stored in the information storage unit 164. Here, the size of the band used to perform the transmission between the second base station 150 and the mobile station 170 may be calculated by using the number of slots, and a data rate indicating how much information transmitted by the predetermined number of slots may be calculated by the AMC level.

Subsequently, the amount of traffic used by the mobile station 170 having performed the handover to the second base station 150 may be extracted based on the band size and the data rate. That is, when the number of slots and the AMC level are analyzed, the downlink/uplink resources allocated to the mobile station 170 having performed handover and including the basic CID may be calculated, and the size of the downlink/uplink resources are the amount of traffic used in one transmission frame by the mobile station 170 using the basic CID in the base stations 150.

A method for measuring and analyzing the amount of traffic of the mobile station 170 by using the traffic measuring device 160 will be described with reference to FIG. 5.

FIG. 5 shows a flowchart representing the method for measuring and analyzing the amount of traffic of the mobile station 170 according to the exemplary embodiment of the present invention.

As shown in FIG. 5, the frame receiving unit 161 of the traffic measuring device 160 receives the downlink frame broadcasted from the second base station 150 to the mobile station 170, and receives the downlink MAP IE (here, the downlink MAP IE is included in the downlink MAP) transmitted by the downlink frame in step S100. Here, the mobile station 170 is a mobile station having performed the handover from the first base station 155 to the second base station 150.

Subsequently, the DL basic CID information extracting unit 162 extracts the downlink basic CID allocated to the mobile station, the number of slots allocated to the basic CID, and the AMC level information of the slot from the downlink MAP IE, and stores them in the information storage unit 164 in steps S10 and S120.

In addition, the UL basic CID information extracting unit 163 extracts the uplink basic CID, the number of slots allocated to the basic CID, and the AMC level of the slots from the uplink MAP IE received through the frame receiving unit 161, and stores them in the information storage unit 164.

The number of slots and the AMC level of each slot are extracted for each transmission frame, and are stored in the information storage unit 164 in steps S130 to S150. In the above process, the traffic measuring device 160 may calculate the size of the downlink/uplink resources allocated to the mobile station 170 having the predetermined CID.

When the size of the downlink/uplink resources is calculated, the RNG-RSP receiving unit 166 of the traffic measuring device 160 determines in step S160 whether there is an RNG-RSP message transmitted from the second base station 150 to the mobile station 170. When there is an RNG-RSP message, the RNG-RSP receiving unit 166 receives the corresponding RNG-RSP message in step S170. In this case, when the mobile station 170 performs the handover from the first base station to the second base station or the mobile station 170 performs the initial ranging operation in the second base station, the RNG-RSP message is broadcasted.

When the RNG-RSP receiving unit 166 receives the RNG-RSP message, the handover ID determining unit 167 determines in step S180 whether the received RNG-RSP message includes the handover ID indicating the handover. When the RNG-RSP message includes the handover ID, since the mobile station 170 receiving the RNG-RSP message is a mobile station having performed the handover from the first base station 155 to the second base station 150, the MAC address of the mobile station 170, the basic CID, and the handover ID are stored in the information storage unit 164 to correspond to the number of slots and the AMC level in step S190.

However, when the received RNG-RSP message does not include the handover ID, i.e., when the RNG-RSP message is transmitted between the mobile station 170 and the base stations 150 and 155 to perform the initial ranging, the step S160 for determining whether there is an RNG-RSP message is performed again. In this case, the amount of traffic of the mobile station 170 having no handover ID may be measured, but, it is described in the exemplary embodiment of the present invention that the amount of traffic of the mobile station having performed the handover is measured. However, it is not limited thereto. For example, when the RNG-RSP message includes no handover ID, the step S160 for determining whether there is an RNG-RSP message is not performed again, but a following process for measuring the amount of traffic of the corresponding mobile station may be performed.

When the MAC address of the mobile station 170, the basic CID, the handover ID, the number of slots, and the AMC level are stored in step S190, the traffic calculating unit 165 calculates the amount of traffic used by the mobile station having performed handover from the first base station 155 to the second base station 150 in step S200. The size of the uplink and downlink bands transmitted between the base station 150 and the mobile station 170 may be calculated by the number of slots, and a data rate indicating how much information is transmitted by the predetermined number of slots may be calculated by the AMC level. Accordingly, when the number of slots and the AMC level are analyzed, the sizes of the uplink and downlink resources allocated to the mobile station 170 having the predetermined basic CID may be detected, and therefore the amount of traffic may be calculated.

When it is determined in step S160 that the RNG-RSP message is not broadcasted, the basic CID of the mobile station 170 stored in the traffic measuring device 160 in step S110 is searched from the basic CIDs stored in step S190, the MAC address of the mobile station 170 mapped to the searched basic CID is detected, and the detected MAC address and the corresponding basic CID are mapped and stored in step S210.

After performing the step S210, the traffic measuring device 160 may store the MAC addresses of the mobile station 170 that correspond to the basic CIDs broadcasted from the base station 150 through the downlink MAP IE. Here, since the MAC address of the mobile station 170 identifies a predetermined mobile station 170 from the plurality of mobile stations, it is required to store the MAC address.

Subsequently, the traffic measuring device 160 maps the number of downlink slots allocated for each basic CID of the mobile station 170 stored in step S110 and the AMC level to the values stored in step S210, and stores them in step S220. After performing the step S220, the traffic measuring device 160 may store the downlink resources allocated by the base station 150 to each mobile station 170 receiving the predetermined basic CID having the predetermined MAC address.

When the number of downlink slots and the AMC level are stored in step S220, the traffic measuring device 160 searches the basic CID of the mobile station 170 stored in step S140 from the basic CIDs stored in step S190 to store the number of uplink slots allocated to each mobile station 170 and the uplink AMC level. The MAC address of the mobile station mapped to the searched basic CID is detected, and the detected MAC address and the corresponding basic CID are mapped and stored in step S230.

After performing the step S230, traffic measuring device 110 may store the MAC addresses of the mobile station 170 that correspond to the basic CIDs broadcasted by the base station 150 through the uplink MAP IE. Then, the number of uplink slots allocated to each basic CID of the mobile station 170 and the AMC level stored in step S150 are mapped to the values stored in step S230, and they are stored in step S240.

After performing the step S240, the traffic measuring device 110 may store the size of the uplink resources allocated to each mobile station 170 receiving the predetermined basic CID having the predetermined MAC address.

The flowchart shown in FIG. 5 shows a traffic measuring process in one transmission frame, and the traffic measuring process is performed by the traffic measuring device 110 in each transmission frame. That is, the steps S100 to S240 are performed in each transmission frame of the portable Internet system.

As described, in transmission frames used while the mobile station 170 accesses the second base station 150 after the mobile station 170 performs the handover from the first base station 155 to the second base station 150, when the number of slots and the AMC level allocated by the second base station 150 are analyzed, all traffic used by the corresponding mobile station 170 may be measured. When the above process is performed for the mobile stations 170 having the handover ID among the mobile terminals accessed to the second base station 150, the amount of traffic used by the individual mobile stations 170 having performed the handover may be measured.

According to the exemplary embodiment of the present invention, without changing a configuration of the mobile communication system, the amount of traffic used by each mobile subscriber station having performed the handover may be measured and analyzed.

In addition, since the mobile station used to measure and analyze the amount of traffic is realized as a simplified terminal, it may be used by any base station.

Further, the amount of traffic of the subscriber station using a borrowed network may be measured and analyzed.

The above-described methods and apparatuses are not only realized by the exemplary embodiment of the present invention, but, on the contrary, are intended to be realized by a program for realizing functions corresponding to the configuration of the exemplary embodiment of the present invention or a recording medium for recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for measuring an amount of traffic used in a second base station by a mobile station performing a handover from a first base station to the second base station, by a traffic measuring device of a mobile communication system, the method comprising:
extracting downlink resource size information for each mobile station identifier based on downlink MAP information elements of a transmission frame broadcasted from the second base station;
extracting uplink resource size information for each mobile station identifier based on uplink MAP information elements of the transmission frame broadcasted from the second base station;
when a handover identifier (ID) indicating the handover of the mobile station exists in a ranging response message broadcasted from the second base station, setting the handover ID to correspond to the mobile station identifier corresponding to the mobile station identifier of the ranging response message; and
measuring the amount of traffic used by the mobile station having performed the handover in the second base station based on the downlink resource size information, the uplink resource size information, and the handover ID.

2. The method of claim 1, wherein the downlink resource size information is first mobile station identifier information comprising the number of downlink slots corresponding to a predetermined mobile station identifier and an adaptive modulation and coding (AMC) level of each downlink slot, and the uplink resource size information is second mobile station identifier information comprising the number of uplink slots corresponding to the predetermined mobile station identifier and the AMC level of each uplink slot.

3. The method of claim 1, wherein the setting of the handover ID to correspond to the mobile station identifier comprises:
receiving a ranging response message in response to a ranging request transmitted from the mobile station including a predetermined medium access control (MAC) address broadcasted from the second base station, the ranging response message including the mobile station identifier allocated to the MAC address;
extracting the MAC address and the mobile station identifier from the ranging response message;
determining whether the ranging response message includes the handover ID; and
mapping the handover ID to the MAC address and the mobile station identifier when the handover ID exists.

4. The method of claim 3, wherein the measuring of the amount of traffic comprises:
identifying the mobile station identifier allocated to the mobile station including the predetermined MAC address from the ranging response message;
searching the stored downlink and uplink resource size information based on the identified mobile station identifier, and detecting downlink and uplink resource sizes allocated to the mobile station including the mobile station identifier; and
measuring the amount of traffic of the mobile station including the mobile station identifier based on the detected downlink and uplink resource sizes.

5. The method of claim 2, wherein, when the ranging response message is not broadcasted,
mapping the first mobile station identifier information generated in the extracting of the downlink resource size information and the MAC address of the mobile station, and
mapping the second mobile station identifier information generated in the extracting of the uplink resource size information and the MAC address of the mobile station.

6. The method of claim 3, further comprising:
receiving a downlink frame broadcasted from the base station; and
storing the MAC address included in burst information of the received downlink frame and the mobile station identifier information allocated to the MAC address.

7. The method of claim 1, wherein the mobile station identifier is a basic connection identifier (CID).

8. A device for measuring an amount of traffic used in a second base station by a mobile station performing a handover from a first base station to the second base station in a mobile communication system, the device comprising:
a frame receiving unit for receiving a downlink frame broadcasted from the second base station;
a downlink/uplink mobile station identifier information extracting unit for extracting predetermined mobile station identifier information based on a downlink MAP information element and an uplink MAP information element included in the received downlink frame;
a handover identifier (ID) determining unit for determining whether a ranging response message broadcasted from the second base station includes a handover ID indicating the handover of the mobile station;
an information storage unit for storing the extracted mobile station identifier information and the handover ID; and
a traffic calculating unit for calculating the amount of the traffic of the mobile station having performed the handover to the second base station based on the downlink/uplink mobile station identifier and the information stored in the downlink/uplink mobile station identifier.

9. The device of claim 8, wherein the mobile station identifier information comprises the number of uplink/downlink slots allocated to the mobile station identifier and the AMC level of the uplink/downlink slots.

10. The device of claim 8, further comprising a ranging response message determining/receiving unit for determining whether a ranging response message transmitted from the base station exists, receiving the ranging response message when the ranging response message exists, and transmitting the ranging response message to the handover ID determining unit.

11. The device of claim 10, wherein the downlink/uplink mobile station identifier and medium access control (MAC) address mapping/storing unit uses an MAC address of the mobile station included in the ranging response message to map the downlink/uplink mobile station identifier.

12. The device of claim 9, wherein the mobile station identifier is a basic connection ID (CID).
